(19) United States
(12) Patent Application Publication
(10) Pub. No.: US 2009/0316572 A1
(43) Pub. Date: Dec. 24, 2009

(54) METHOD AND SYSTEM FOR MANAGING PORT STATUSES OF A NETWORK DEVICE AND RELAY DEVICE

(75) Inventors: Rihua ZHANG, Shenzhen (CN); Ran SU, Shenzhen (CN); Yong YANG, Shenzhen (CN); Shifeng MAO, Shenzhen (CN); Guibin HOU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: CHENGDU HUAWEI SYMANTEC TECHNOLOGIES CO., LTD., Chengdu (CN)

(21) Appl. No.: 12/478,131

(22) Filed: Jun. 4, 2009

(30) Foreign Application Priority Data
Jun. 20, 2008 (CN) 200810115302.8
Jan. 16, 2009 (CN) PCT/CN2009/070180

(51) Int. Cl. G06F 11/00

(52) U.S. Cl. 370/220

(57) ABSTRACT

A method, a system for managing port status of a network device, and a relay device are provided in the field of network management. The method includes the following steps. A relay device detects working status of ports in a logic group, and the ports are mounted on the relay device and connected to an upstream/downstream device. When it is detected that the working status of a port in the logic group is Down, the relay device sets the working status of the other ports in the logic group as Down, so that the upstream/downstream device of the relay device switches a terminal service to a standby link according to the ports' Down status in the logic group being detected. The relay device includes a detecting module and a setting module. The system includes a relay device and an upstream/downstream device of the relay device. The technical solution provided in the embodiments of the present disclosure guarantees that the terminal service is transmitted uninterruptedly.

### CROSS-REFERENCE TO RELATED APPLICATIONS

This application claims priority to Chinese Patent Application No. 200810115302.8, filed Jun. 20, 2008, and International Patent Application No. PCT/CN2009/070180, filed Jan. 16, 2009, both of which are hereby incorporated by reference in their entirety.

### FIELD OF THE TECHNOLOGY

The present disclosure relates to the field of network management, and more particularly to a method and a system for managing port statuses of a network device, and a relay device.

### BACKGROUND

In the current network applications, users have an increasingly high requirement on the reliability of the network. Especially, as for some important service entry or access points, such as internet access points of enterprises and database servers of banks, the users always expect that the network operates uninterruptedly. But if only one network device is adopted at such service point, the system inevitably bear the risk of network interruption due to a single point failure, regardless of how high the reliability of the network device is.

A networking solution of two-node cluster hot backup may well solve the problem about the poor reliability of the single network device in the current network applications. In this solution, two dynamic virtual links are employed, in which one link is an active link, and the other link is a standby link. Once the active link fails, the system switches the service to the standby link to perform normal transmission, so as to guarantee the continuity of the service transmission. FIG. 1 is a schematic diagram of a networking solution of two-node cluster hot backup according to the conventional art. In a normal situation, the service is transmitted via the active link of Router A→Firewall A→Router C. When the active link fails, the service is switched to the standby link of Router B→Firewall B→Router D, so as to guarantee the continuity for the transmission of the terminal service.

If the port via which the firewall A and the router C are connected fails, the service to be transmitted from a terminal A to a terminal B may be actually transmitted via a link of Router C→Router D→Firewall B→Router B. The service to be returned from the terminal B to the terminal A may be actually transmitted via the link of Router A→Firewall A→Router C. Since the port via which the firewall A and the router C are connected fails, the link between the firewall A and the router C is interrupted, and thus the service to be returned from the terminal B to the terminal A cannot pass through. In this case, since the router A fails to sense the status of the port between the firewall A and the router C, the route cannot be switched. As a result, the transmission of the terminal service is interrupted.

During researching into the conventional art, the inventor finds that there exists at least the following problem in the conventional art.

Currently, the networking situations are increasingly complicated, and when the networking solution of two-node cluster hot backup is adopted, if the port of the relay device fails, the upstream/downstream device connected to the relay device cannot switch the terminal service to the standby link, which results in the interruption of the transmission of the terminal service.

### SUMMARY

Embodiments of the present disclosure provide a method and a system for managing port status of a network device, and a relay device, to avoid the interruption of the transmission of the terminal service.

A method for managing port status of a network device includes the following steps.

A relay device detects working status of ports in a logic group, and the ports are mounted on the relay device and connected to an upstream/downstream device.

Working status of the other ports in the logic group are all set as the Down status when it is detected that the working status of any port in the logic group is Down, so that the upstream/downstream device of the relay device switches the terminal service to a standby link according to the ports' Down status in the logic group being detected.

A relay device includes a detecting module and a setting module.

The detecting module is configured to detect working status of ports in a logic group, in which the ports are mounted on the relay device and connected to an upstream/downstream device.

The setting module is configured to set the other ports in the logic group as the Down status when it is detected by the detecting module that the working status of any port in the logic group is Down.

A system for managing port status of a network device includes: a relay device configured to detect working status of ports in a logic group and set the other ports in the logic group as Down when it is detected that the working status of any port in the preset logic group is Down; and an upstream/downstream device of the relay device configured to switch the terminal service to a standby link according to the ports' Down status in the relay device, in which the ports are mounted on the relay device and connected to the upstream/downstream device.

In the technical solution according to the embodiments of the present disclosure, the relay device detects the working status of the ports in the logic group, and when it is detected that the working status of any port in the logic group is a Down status, the relay device sets the working status of all the other ports in the logic group as the Down status. Thus, the upstream/downstream device of the relay device switches the terminal service to a standby link when it is detected that the ports of the relay device are in the Down status, so as to guarantee that the terminal service is transmitted uninterruptedly.

### BRIEF DESCRIPTION OF THE DRAWING

FIG. 1 is a schematic diagram of a networking solution of two-node cluster hot backup according to the conventional art;

FIG. 2 is a flowchart of a method for managing port status of a network device according to an embodiment of the present disclosure;

FIG. 3 is a schematic diagram of a networking solution applied by a method for managing port status of a network device according to an embodiment of the present disclosure;

FIG. 4 is a schematic diagram of a relay device according to an embodiment of the present disclosure; and

FIG. 5 is a schematic diagram of a system for managing port status of a network device according to an embodiment of the present disclosure.

### DETAILED DESCRIPTION

In order to make objectives, technical solutions, and advantages of the present disclosure more comprehensible, embodiments of the present disclosure are further described below in detail with reference to the drawings. Apparently, the embodiments described herein are only a part of the embodiments of the present disclosure, rather than all the embodiments of the present disclosure. Based on the embodiments of the present disclosure described herein, any other embodiment achieved by those ordinary skilled in the art without any creative work falls within the scope of the present disclosure.

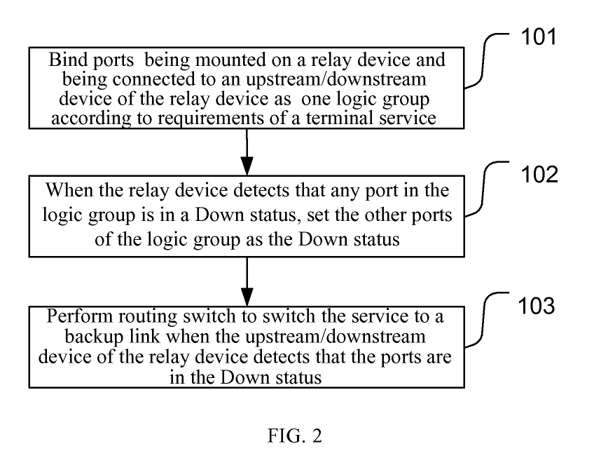

An embodiment of the present disclosure provides a method for managing port status of a network device, which includes the following processes. A relay device detects working status of ports in a preset logic group, in which the ports are mounted on the relay device and connected to an upstream/downstream device. When it is detected that the working status of any port in the preset logic group is a Down status, working status of all the other ports in the preset logic group are set as the Down status. Thus, when it is detected that the ports of the relay device are in the Down status, the upstream/downstream device of the relay device switches the terminal service to a standby link, so as to guarantee the normal transmission of the terminal service. As shown in FIG. 2, the embodiment of the present disclosure includes the following processes.

Block 101, the ports being mounted on the relay device and being connected to the upstream/downstream device of the relay device are bound as one logic group.

A list of association relations between port numbers and logic group numbers is created in the relay device according to the requirements of the terminal services, and a plurality of ports of the upstream/downstream device being connected to the relay device are assigned to the same logic group number. For example, when a terminal service is transmitted through a port A in the relay device and being connected to the upstream device of the relay device and a port B in the relay device and being connected to the downstream device of the relay device, the port A and the port B may be assigned to the same logic group. For another example, when a terminal service is transmitted through a port C and a port D in the relay device and being connected to the upstream device of the relay device and a port E and a port F in the relay device and being connected to the downstream device of the relay device, the ports C, D, E, and F are assigned to the same logic group. The relations between the ports of the relay device and the logic group are not limited to the above embodiment, and in the practical applications, the relation may be set correspondingly according to the requirements of the terminal services.

Block 102, the relay device detects the working status of the ports in the preset logic group, and when it is detected that any port in the preset logic group fails, that is, when it is detected that any port in the preset logic group is in a Down status, the relay device sets all the other ports in the preset logic group as the Down status.

Block 103, the upstream/downstream device of the relay device switches the terminal service to a standby link when it is detected that the ports of the relay device are in the Down status.

Block 102, all the port status in the logic group of the relay device is the Down status, and the change of the port status causes a failure of the uplink/downlink of the relay device. In this case, the upstream/downstream device connected to the relay device senses the failure of the ports through the Down status of the ports, and meanwhile switches the terminal service to the standby link.

Moreover, when the relay device detects that all the ports in the preset logic group work normally, the relay device sets all the ports in the preset logic group as an UP status. In this case, the upstream/downstream device connected to the relay device senses that the ports work normally through the UP status of the ports, and meanwhile switches the service back to an active link.

The embodiment is described below in detail through the following scenarios.

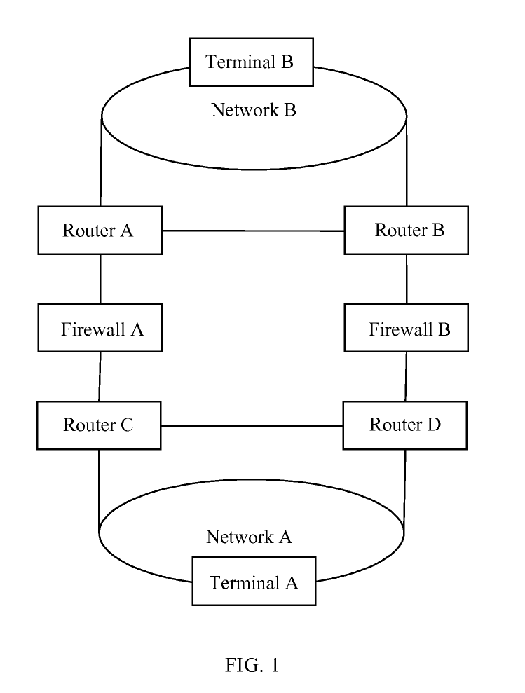

The schematic view of a networking solution in the first scenario is still based on the networking shown in FIG. 1. As shown in FIG. 1, firewalls A and B are relay devices (the relay device may also be a router, a server, or a switch), the active link is Router A→Firewall A→Router C, and the standby link is Router B→Firewall B→Router D. Under a normal situation, the services are transmitted via the active link. According to the requirements of the terminal services, a plurality of ports in the firewall A and being connected to the router A and the router C are bound as a first logic group, and a plurality of ports in the firewall B and being connected to the router B and the router D are bound as a second logic group. In an initial status, the plurality of ports in the logic groups of the firewall A and the firewall B are in an UP status. The firewall A detects whether the ports in the first logic group stored are in a Down status or not, and when it is detected that the working status of any port in the first logic group is the Down status, the firewall A sets working status of the other ports in the first logic group as the Down status as well. In this case, both the router A and the router C can sense the failure of the ports, and perform the routing switch, so as to switch the service from the active link to the standby link. When the firewall A detects that all the ports in the first logic group work normally, the firewall A sets working status of the ports in the first logic group as the UP status. In this case, both the router A and the router C can sense that the ports are normal, and perform the routing switch, so as to switch the terminal service from the standby link back to the active link, thereby guaranteeing that the terminal service is transmitted uninterruptedly.

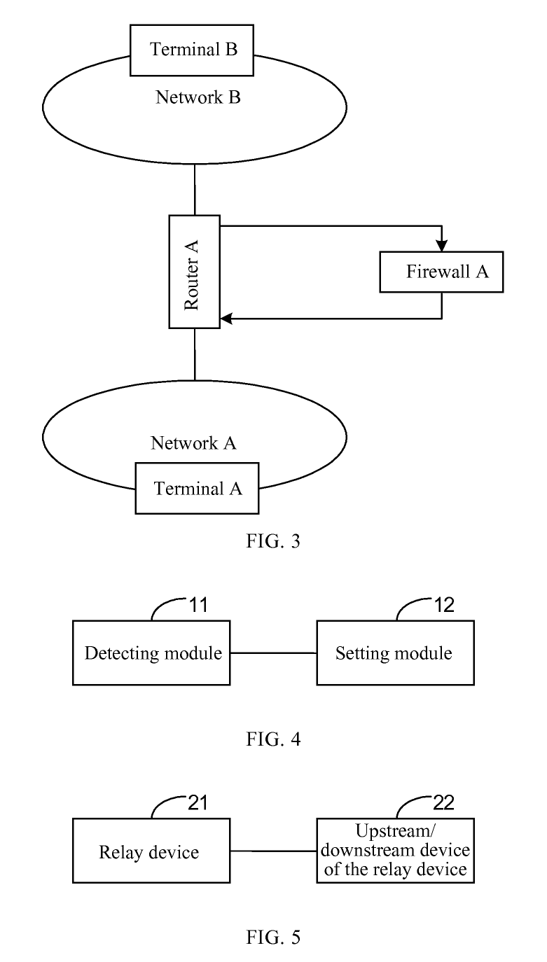

The schematic diagram of a networking solution in a second scenario is shown in FIG. 3. Referring to FIG. 3, a network A is connected with a network B through the router A, and the router A is connected to the firewall A (the firewall A serves as the relay device) via two links. In a normal situation, a terminal service is sent to the firewall A through the router A, the firewall filters the service and then sends the service back to the router A, and then the router A sends the filtered terminal service to the terminal in the network. Such service transmission path is referred to as a high-priority link (also referred to as an active link). A low-priority link (also referred to as a standby link) refers to transmitting the service between networks directly through the router A. A plurality of ports in the firewall A and being connected to the router A is bound to the same logic group. When the firewall A detects that the working status of any port in the logic group is the Down status, the firewall A sets working status of all the other ports in the logic group as the Down status. In this case, the router A detects that the failure of the ports of the firewall A, and switches the terminal service to the low-priority link. When it is detected that all the ports in the logic group work normally, the firewall A sets working status of all the ports in the logic group as the UP status. In this case, the router A detects that the all ports of the firewall A work normally, and switches the terminal service back to the high-priority link, so as to guarantee that the terminal service is transmitted uninterruptedly.

A relay device is further provided in an embodiment of the present disclosure. The relay device may be a firewall, a router, a switch, or a server and so on. Particularly, the relay device stores a list of association relations between port numbers and logic group numbers therein, and a plurality of ports are assigned for the same logic group number. The relay device detects the working status of the ports in the logic group. When it is detected that the working status of any port in the logic group is a Down status, the relay device sets working status of all the other ports in the logic group as the Down status. When it is detected that all the ports in the logic group work normally, the relay device sets working status of all the ports in the logic group as an UP status.

FIG. 4 shows a schematic diagram of a relay device according to an embodiment of the present disclosure. Referring to FIG. 4, the relay device includes a detecting module 11 and a setting module 12. The detecting module 11 is configured to detect working status of ports in a preset logic group, in which the ports are mounted on the relay device and connected to an upstream/downstream device. When the detecting module 11 detects that the working status of any port in the preset logic group is the Down status, the setting module 12 is configured to set working status of all the other ports in the preset logic group as the Down status.

When the detecting module 11 detects that all the ports in the preset logic group work normally, the setting module 12 is further configured to set working status of all the ports in the preset logic group as the UP status.

A system for managing port status of a network device is further provided in an embodiment of the present disclosure. As shown in FIG. 5, the system includes a relay device 21 and an upstream/downstream device 22 of the relay device. The relay device 21 is configured to detect working status of ports in a preset logic group. When it is detected that the working status of any port in the preset logic group is a Down status, the relay device 21 is further configured to set working status of the other ports in the preset logic group as the Down status. The ports are mounted on the relay device and connected to the upstream/downstream device. The upstream/downstream device 22 of the relay device is configured to switch the terminal service to a standby link when it is detected that the ports of the relay device 21 are in the Down status.

Moreover, the relay device 21 is further configured to set working status of all the ports in the preset logic group as an UP status when detecting that all the ports in the preset logic group work normally, so that the upstream/downstream device 22 of the relay device switches the terminal service from the standby link back to the active link when it is detected that the ports of the relay device are in the UP status.

The relay device may be a firewall, a router, a switch, or a server and so on.

In the technical solution according to the embodiments of the present disclosure, the relay device detects the working status of the ports in the preset logic group, and when it is detected that the working status of any port in the preset logic group is a Down status, the relay device sets the working status of all the other ports in the preset logic group as the Down status. Thus, the upstream/downstream device of the relay device switches the terminal service to a standby link when it is detected that the ports of the relay device are in the Down status by the upstream/downstream device, so as to guarantee that the terminal service is transmitted uninterruptedly.

People skilled in this art can understand that the present invention includes a computer readable storage medium having program code stored therein which can be used to instruct a computer to perform any of the methods associated with the above-mentioned embodiments of the present invention. The storage medium comprises the various media which are able to store program codes such as ROM, RAM, diskette or compact disc, etc.

Finally, it should be understood that the above embodiments are only used to illustrate, but not to limit the technical solution of the present disclosure. Despite the detailed description of the present disclosure with reference to above exemplary embodiments, it should be understood that various modifications, changes or equivalent replacements can be made by those skilled in the art without departing from the spirit and scope of the present disclosure and covered in the claims of the present disclosure.

What is claimed is:

1. A method for managing port statuses of a network device, comprising:
detecting, by a relay device, working statuses of ports in a logic group, the ports being mounted on the relay device for connecting to network devices, each of which is either upstream or downstream in a network transmission supported by one of the ports; and
when detecting that the working status of a port in the logic group is Down, setting the working statuses of the other ports in the logic group as Down, so that each of the network devices switches a terminal service to a standby link according to a port's Down status in the logic group being detected by each of the network devices itself.

2. The method for managing port statuses of a network device according to claim 1, the method further comprises:
setting, by the relay device, the working statuses of all ports in the logic group as UP when it is detected that all ports in the logic group work normally, so that each of the network devices switches the terminal service to an active link according to a port's UP status being detected by each of the network devices itself.

3. The method for managing port statuses of a network device according to claim 1, wherein the relay device includes one of a router, a firewall, a switch, and a server.

4. The method for managing port statuses of a network device according to claim 1, wherein the network devices comprise a upstream device of the relay device and a downstream device of the relay device, and the logic group comprises a first port being mounted on the relay device and connected to the upstream device of the relay device, and a second port being mounted on the relay device and connected to the downstream device of the relay device.

5. The method for managing port statuses of a network device according to claim 4, wherein each of the network devices switching a terminal service to a standby link according to a port's Down status in the logic group being detected by each of the network devices itself comprises at least one of:
switching, by the upstream device of the relay device, a terminal service to a standby link according to the first port's Down status being detected by the upstream device of the relay device; and
switching, by the downstream device of the relay device, a terminal service to a standby link according to the second port's Down status being detected by the downstream device of the relay device.

6. A relay device, comprising:
a detecting module, configured to detect working statuses of ports in a logic group, the ports being mounted on the relay device for connecting to network devices, each of which is either upstream or downstream in a network transmission supported by one of the ports; and
a setting module, when the detecting module detects that the working status of a port in the logic group is Down, configured to set the working statuses of the other ports in the logic group as Down.

7. The relay device according to claim 6, wherein the setting module is further configured to set the working statuses of all ports in the logic group as UP when the detecting module detects that all ports in the logic group work normally.

8. The relay device according to claim 6, wherein the relay device includes one of a router, a firewall, a switch, and a server.

9. A system for managing port statuses of a network device, comprising:
a relay device, configured to detect working statuses of ports in a logic group, and when the relay device detects that the working status of a port in the logic group is Down, set the working statuses of the other ports in the logic group as Down; and
network devices, each of which is either upstream or downstream in a network transmission supported by one of the ports being mounted on the relay device for connecting to the network devices, configured to switch a terminal service to a standby link according to a port's Down status in the logic group being detected by each of the network devices itself.

10. The system for managing port statuses of a network device according to claim 9,
the relay device further configured to set the working statuses of all ports in the logic group as UP when detecting that all ports in the logic group work normally; and
each of the network devices further configured to switch the terminal service to an active link according to a port's UP status in the logic group being detected by each of the network devices itself.

11. The system for managing port statuses of a network device according to claim 9, wherein the relay device includes one of a router, a firewall, a switch, and a server.

12. The system for managing port statuses of a network device according to claim 9, wherein the network device comprise a upstream device of the relay device and a downstream device of the relay device, and the logic group comprises a first port being mounted on the relay device and connected to the upstream device of the relay device, and a second port being mounted on the relay device and connected to the downstream device of the relay device.

13. The system for managing port statuses of a network device according to claim 12, the upstream device of the relay device further configured to switch a terminal service to a standby link according to the first port's Down status being detected by the upstream device of the relay device; or
the downstream device of the relay device further configured to switch a terminal service to a standby link according to the second port's Down status being detected by the downstream device of the relay device.

14. A computer readable storage medium comprising program codes for instructing one or more digital processors to manage port statuses of a network device, the program codes including:
instructions for detecting working statuses of ports in a logic group, the ports being mounted on a relay device for connecting to network devices, each of which is either upstream or downstream in a network transmission supported by one of the ports; and
instructions, when detecting that the working status of a port in the logic group is Down, for setting the working statuses of the other ports in the logic group as Down, so that each of the network devices switches a terminal service to a standby link according to a port's Down status in the logic group being detected by each of the network itself.
